(19) United States
(12) Patent Application Publication
(10) Pub. No.: US 2026/0081393 A1
(43) Pub. Date: Mar. 19, 2026

(54) CONNECTION INTERFACE FOR SAFE AND EASILY-REPLACEABLE OVERHEAD LINE SEGMENTS IN STORM-PRONE REGIONS

(71) Applicant: Florida State University Research Foundation, Inc., Tallahassee, FL (US)

(72) Inventors: Jake Robert Scally, Tallahassee, FL (US); Bria Hailey Weisblat, Tallahassee, FL (US); Rian Jackson, Tallahassee, FL (US); Betty Phipps, Tallahassee, FL (US); Brianna Petrus, Tallahassee, FL (US)

(21) Appl. No.: 19/330,436

(22) Filed: Sep. 16, 2025

Related U.S. Application Data
(60) Provisional application No. 63/695,137, filed on Sep. 16, 2024.

(51) Int. Cl. H01R 31/06; H01R 43/26

(52) U.S. Cl. CPC H01R 31/06; H01R 43/26

(57) ABSTRACT

Systems and methods are provided for safe and easily-replaceable overhead line segments for overhead lines, such as power delivery lines or telecommunications lines. A connection interface can be implemented at one or more locations where overhead lines connect, are supported, and/or are particularly vulnerable. The connection at the one or more locations can be tension-based, such that during an event where the overhead lines are under significant stress, at least one segment of the overhead lines can detach.

### CROSS-REFERENCE TO RELATED APPLICATION

This application claims the benefit of U.S. Provisional Application Ser. No. 63/695,137, filed Sep. 16, 2024, the disclosure of which is hereby incorporated by reference in its entirety, including all figures, tables, and drawings.

### BACKGROUND

When a power delivery line is downed, such as due to a tree falling on it, this typically results in multiple power poles being downed, leaving live wires on roads. This is dangerous, leads to long periods of downtime in electrical service in the area, and is costly and time-consuming to repair.

### BRIEF SUMMARY

Embodiments of the subject invention provide novel and advantageous systems and methods for safe and easily-replaceable overhead line segments for overhead lines, such as power delivery lines. A connection interface can be implemented at one or more locations where overhead lines connect, are supported, and/or are particularly vulnerable. The connection at the one or more locations can be tension-based, such that during an event where the overhead line(s)/cable(s) are under significant stress, at least one segment of the overhead line(s)/cable(s) can detach (e.g., at one end or at both ends).

In an embodiment, a system for connecting overhead line segments can comprise: a first connection shell configured to receive a first overhead line segment; a second connection shell configured to receive a second overhead line segment; and a first extended shell configured to removably connect to the first connection shell and to the second connection shell. The first connection shell, the first extended shell, and the second connection shell can all be configured to pass an electrical current and/or a signal from the first overhead line segment to the second overhead line segment. The first connection shell, the first extended shell, and/or the second connection shell can be electrically insulated. Each of the first overhead line segment and the second overhead line segment can be, for example, a power delivery line segment or a telecommunications line segment. The first connection shell, the first extended shell, and the second connection shell can all be configured to pass an electrical current from the first overhead line segment to the second overhead line segment without arcing. The first connection shell can be configured to receive the first overhead line segment at a first side of the first connection shell; the first extended shell can be configured to connect to a second side of the first connection shell at a first side of the first extended shell; the second connection shell can be configured to receive the second overhead line segment at a first side of the second connection shell; and the second connection shell can be configured to connect to a second side of the first extended shell at a second side of the second connection shell; where the second side of the first connection shell is opposite the first side of the first connection shell, the second side of the second connection shell is opposite the first side of the second connection shell, and the second side of the first extended shell is opposite the first side of the first extended shell. The second side of the first connection shell can comprise at least one first connector (e.g., three (or at least three) first connectors); the second side of the second connection shell can comprise at least one second connector (e.g., three (or at least three) second connectors); the first side of the first extended shell can comprise at least one third connector (e.g., three (or at least three) third connectors) configured to line up with the at least one first connector; and/or the second side of the first extended shell can comprise at least one fourth connector (e.g., three (or at least three) fourth connectors) configured to line up with the at least one second connector. Each first connector can be, for example, a female connector. Each second connector can be, for example, a female connector. Each third connector can be, for example, a female connector. Each fourth connector can be, for example, a female connector. A length of the first extended shell can be greater than a length of the first connection shell and a length of the second connection shell. The first connection shell can be configured to connect to the first extended shell, for example, by friction fit or via one or more first spring-loaded latches. The second connection shell can be configured to connect to the first extended shell, for example, by friction fit or via one or more second spring-loaded latches. The system can further comprise: a third connection shell configured to receive the first overhead line segment at an end opposite from that which the first connection shell is configured to receive the first overhead line segment; a fourth connection shell configured to receive a third overhead line segment; and a second extended shell configured to removably connect to the third connection shell and to the fourth connection shell. The third connection shell, the second extended shell, and the fourth connection shell can all be configured to pass an electrical current and/or a signal from the first overhead line segment to the third overhead line segment. The third connection shell, the second extended shell, and/or the fourth connection shell can be electrically insulated. The third connection shell, the second extended shell, and the fourth connection shell can have any of the features of the first connection shell, the first extended shell, and the second connection shell, respectively, as discussed herein.

In another embodiment, a method for connecting overhead line segments can comprise: providing a system having any or all of the features discussed herein (e.g., in the previous paragraph); connecting (removably or non-removably) the first overhead line segment to the first connection shell; connecting (removably or non-removably) the second overhead line segment to the second connection shell; and removably connecting the first connection shell and the second connection shell to the first extended shell. The method can further comprise: connecting (removably or non-removably) the first overhead line segment to the third connection shell; connecting (removably or non-removably) the third overhead line segment to the fourth connection shell; and removably connecting the third connection shell and the fourth connection shell to the second extended shell.

### BRIEF DESCRIPTION OF DRAWINGS

FIG. 1 shows an image of a power delivery line having a connection interface, according to an embodiment of the subject invention.

### DETAILED DESCRIPTION

Embodiments of the subject invention provide novel and advantageous systems and methods for safe and easily-replaceable overhead line segments for overhead lines, such as power delivery lines or telecommunications lines. A connection interface can be implemented at one or more locations where overhead lines connect, are supported, and/or are particularly vulnerable. The connection at the one or more locations can be tension-based, such that during an event where the overhead line(s)/cable(s) are under significant stress, at least one segment of the overhead line(s)/cable(s) can detach (e.g., at one end or at both ends).

When a tree or other structure (e.g., part of a house) falls on an overhead line (e.g., a power delivery line and/or a telecommunications line), such as during a storm or other disaster, it typically results in multiple poles (e.g., power poles or telecommunications poles) being downed. Embodiments of the subject invention address this problem by providing connection interfaces for overhead lines (e.g., power delivery lines and/or telecommunications lines) such that only a segment of the overhead line would fall to the ground in such a scenario. The segment falling to the ground can even be in a non-live state, such that no current (and/or telecommunications signal) is running through it because it has disconnected from the remainder of the overhead line, thereby vastly increasing the safety of the situation.

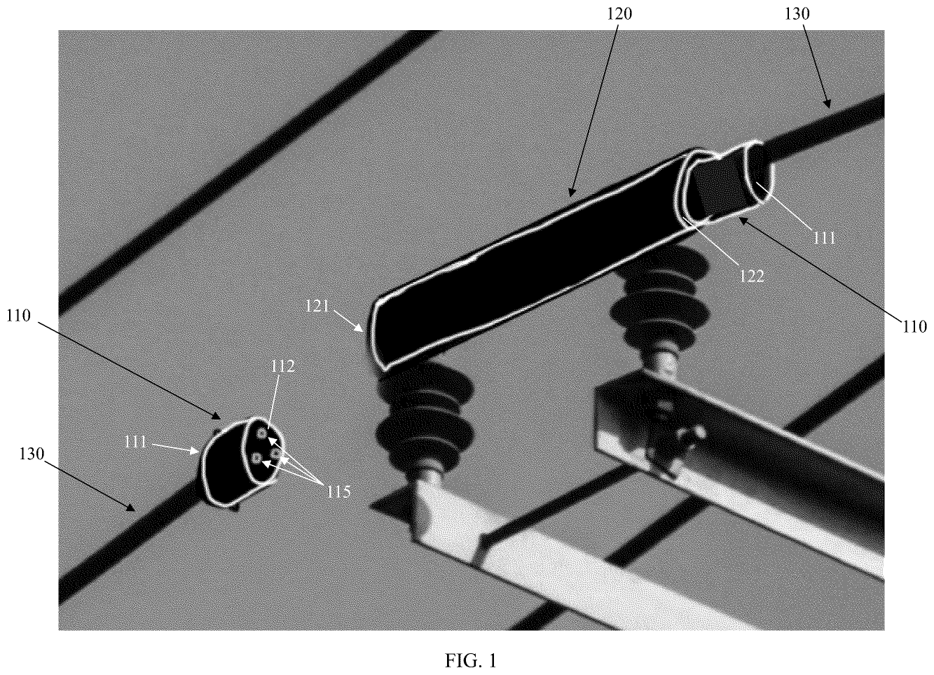

FIG. 1 shows an image of a power delivery line having a connection interface, according to an embodiment of the subject invention. Though FIG. 1 is discussed herein with reference to a power delivery line, it is applicable to other types of overhead lines. Referring to FIG. 1, the connection interface can include at least one connection shell 110 configured to connect power delivery line segments 130 to each other without arcing. The connection interface can further include an extended shell 120, which can be provided between two power delivery line segments 130 and two connection shells 110. The connection shell(s) 110 and the extended shell 120 can be electrically insulated, while allowing current (and/or telecommunications signal, such as in the case of a telecommunications line) to flow through them. Each connection shell 110 can include a first side 111 for receiving the power delivery line segment 130 and a second side 112 opposite the first side 111 and configured to connect to the extended shell 120 (or to another connection shell 110). The extended shell 120 can include a first side 121 for receiving a first connection shell 110 and a second side 122 for receiving a second connection shell 120. The second side 112 of each connection shell 110 can include at least one connector 115 (e.g., three, or at least three, connectors 115), and both sides 121,122 of the extended shell can include at least one connector (e.g., three, or at least three, connectors) (not pictured) configured to join with the connector(s) 115 on the second side 112 of the connection shell(s) 110. Each connector 115 of each connection shell 110 can be, for example, a female connector, though embodiments are not limited thereto. Each connector of each extended shell 120 can be, for example, a female connector, though embodiments are not limited thereto. In some embodiments, each joint (i.e., where 112 meets 121 and where 112 meets 122) can have a female-female socket including the connectors from the connection shell 110 and the extended shell 120. The connection shell 110 and the extended shell 120 can be configured to allow current from the power delivery line segment 130 (and/or telecommunications signal from a telecommunications line segment) to flow therethrough, such that the current (and/or telecommunications signal) can flow from one power delivery line segment 130 on a first side of the connection interface, through the connection interface (including the connection shells 110 and the extended shell 120), to a power delivery line segment 130 on a second side of the connection interface opposite from the first side.

The joints of the connection interface can include the mechanism by which the power delivery line segment 130 are secured and the tension is set. The mechanism can include, for example, a simple friction fit, one or more spring-loaded latches, or other similar connection mechanisms. When a large force pulls down on a power delivery line segment 130 connected to the connection interface (e.g., connected to a connection shell 110), the power delivery line segment 130 can break away from the extended shell 120 and/or the connection shell 110 and fall (safely, or relatively safely) to the ground, while not pulling other power delivery line segments 130 or power poles with it. The power delivery line segment 130 can be connected to a connection interface (of embodiments of the subject invention) at both ends, helping to facilitate its breakaway without bring other power delivery line segments 130 or power poles with it.

The downed power delivery line segment 130 can be retrieved and reconnected to the connection interface(s), saving on expensive materials. In the event that the connection shell 110 and/or extended shell 120 is damaged, any damaged elements can simply be replaced when the downed power delivery line segment 130 is reconnected.

Embodiments of the subject invention greatly reduce electrical and/or network downtime in the event of an object falling on a power delivery line. This is desirable for various telecommunications and power delivery companies to minimize costs and downtime, particularly in storm-prone regions.

Inline tension disconnect (ITD) switches, such as the Hubbell Power Systems Line Tension Disconnect Switch, are extremely costly, on the order of $1,000 per connection. They are not suitable for connecting power delivery line segments as discussed herein, and they also cannot be reconnected once the connection is broken. On the other hand, embodiments of the subject invention can minimize downtime in disaster-prone regions, with systems and methods that advantageously provide ease of replacement and reconnection. The system can be modular and/or joinable, connecting segments of overhead lines, thereby reducing the time and cost of recovery, repair, and restoration of services (e.g., for telecommunications companies and power delivery companies).

When ranges are used herein, combinations and subcombinations of ranges (e.g., subranges within the disclosed range) and specific embodiments therein are intended to be explicitly included. When the term “about” is used herein, in conjunction with a numerical value, it is understood that the value can be in a range of 95% of the value to 105% of the value, i.e., the value can be +/−5% of the stated value. For example, “about 1 kg” means from 0.95 kg to 1.05 kg.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

What is claimed is:

1. A system for connecting overhead line segments, the system comprising:
a first connection shell configured to receive a first overhead line segment;
a second connection shell configured to receive a second overhead line segment; and
a first extended shell configured to removably connect to the first connection shell and to the second connection shell,
wherein the first connection shell, the first extended shell, and the second connection shell are all configured to pass at least one of an electrical current and a signal from the first overhead line segment to the second overhead line segment, and
wherein the first connection shell, the first extended shell, and the second connection shell are all electrically insulated.

2. The system according to claim 1, wherein each of the first overhead line segment and the second overhead line segment is a power delivery line segment.

3. The system according to claim 2, wherein the first connection shell, the first extended shell, and the second connection shell are all configured to pass an electrical current from the first overhead line segment to the second overhead line segment without arcing.

4. The system according to claim 1, wherein each of the first overhead line segment and the second overhead line segment is a telecommunications line segment.

5. The system according to claim 1, wherein the first connection shell is configured to receive the first overhead line segment at a first side of the first connection shell,
wherein the first extended shell is configured to connect to a second side of the first connection shell at a first side of the first extended shell,
wherein the second side of the first connection shell is opposite the first side of the first connection shell,
wherein the second connection shell is configured to receive the second overhead line segment at a first side of the second connection shell,
wherein the second connection shell is configured to connect to a second side of the first extended shell at a second side of the second connection shell,
wherein the second side of the second connection shell is opposite the first side of the second connection shell, and
wherein the second side of the first extended shell is opposite the first side of the first extended shell.

6. The system according to claim 5, wherein the second side of the first connection shell comprises at least one first connector,
wherein the second side of the second connection shell comprises at least one second connector,
wherein the first side of the first extended shell comprises at least one third connector configured to line up with the at least one first connector, and
wherein the second side of the first extended shell comprises at least one fourth connector configured to line up with the at least one second connector.

7. The system according to claim 6, wherein the at least one first connector comprises three first connectors,
wherein the at least one second connector comprises three second connectors,
wherein the at least one third connector comprises three third connectors, and
wherein the at least one fourth connector comprises three fourth connectors.

8. The system according to claim 6, wherein each first connector is a female connector.

9. The system according to claim 6, wherein each second connector is a female connector.

10. The system according to claim 6, wherein each third connector is a female connector.

11. The system according to claim 6, wherein each fourth connector is a female connector.

12. The system according to claim 1, wherein a length of the first extended shell is greater than a length of the first connection shell and a length of the second connection shell.

13. The system according to claim 1, wherein the first connection shell is configured to connect to the first extended shell by friction fit.

14. The system according to claim 1, wherein the first connection shell is configured to connect to the first extended shell via one or more first spring-loaded latches.

15. The system according to claim 1, wherein the second connection shell is configured to connect to the first extended shell by friction fit.

16. The system according to claim 1, wherein the second connection shell is configured to connect to the first extended shell via one or more second spring-loaded latches.

17. The system according to claim 1, further comprising:
a third connection shell configured to receive the first overhead line segment at an end opposite from that which the first connection shell is configured to receive the first overhead line segment;
a fourth connection shell configured to receive a third overhead line segment; and
a second extended shell configured to removably connect to the third connection shell and to the fourth connection shell,
wherein the third connection shell, the second extended shell, and the fourth connection shell are all configured to pass at least one of an electrical current and a signal from the first overhead line segment to the third overhead line segment, and
wherein the third connection shell, the second extended shell, and the fourth connection shell are all electrically insulated.

18. The system according to claim 17, wherein each of the first overhead line segment and the second overhead line segment is a power delivery line segment,
wherein the first connection shell, the first extended shell, and the second connection shell are all configured to pass an electrical current from the first overhead line segment to the second overhead line segment without arcing,
wherein each of the first overhead line segment and the second overhead line segment is a telecommunications line segment,
wherein the first connection shell is configured to receive the first overhead line segment at a first side of the first connection shell,
wherein the first extended shell is configured to connect to a second side of the first connection shell at a first side of the first extended shell,
wherein the second side of the first connection shell is opposite the first side of the first connection shell,
wherein the second connection shell is configured to receive the second overhead line segment at a first side of the second connection shell,
wherein the second connection shell is configured to connect to a second side of the first extended shell at a second side of the second connection shell,
wherein the second side of the second connection shell is opposite the first side of the second connection shell,
wherein the second side of the first extended shell is opposite the first side of the first extended shell,
wherein the second side of the first connection shell comprises at least one first connector,
wherein the second side of the second connection shell comprises at least one second connector,
wherein the first side of the first extended shell comprises at least one third connector configured to line up with the at least one first connector,
wherein the second side of the first extended shell comprises at least one fourth connector configured to line up with the at least one second connector,
wherein a length of the first extended shell is greater than a length of the first connection shell and a length of the second connection shell,
wherein the first connection shell is configured to connect to the first extended shell by friction fit,
wherein the first connection shell is configured to connect to the first extended shell via one or more first spring-loaded latches,
wherein the second connection shell is configured to connect to the first extended shell by friction fit, and
wherein the second connection shell is configured to connect to the first extended shell via one or more second spring-loaded latches.

19. A method for connecting overhead line segments, the method comprising:
providing the system according to claim 17;
connecting the first overhead line segment to the first connection shell;
connecting the second overhead line segment to the second connection shell;
removably connecting the first connection shell and the second connection shell to the first extended shell;
connecting the first overhead line segment to the third connection shell;
connecting the third overhead line segment to the fourth connection shell; and
removably connecting the third connection shell and the fourth connection shell to the second extended shell.

20. A method for connecting overhead line segments, the method comprising:
providing the system according to claim 1;
connecting the first overhead line segment to the first connection shell;
connecting the second overhead line segment to the second connection shell; and
removably connecting the first connection shell and the second connection shell to the first extended shell.
